(19) United States
(12) Patent Application Publication
(10) Pub. No.: US 2017/0325598 A1
(43) Pub. Date: Nov. 16, 2017

(54) Seat Cover

(71) Applicant: Lee Williams, Centennial, CO (US)

(72) Inventor: Lee Williams, Centennial, CO (US)

(21) Appl. No.: 15/153,833

(22) Filed: May 13, 2016

(51) Int. Cl. A47C 31/11; A47C 7/62; G09F 23/00

(52) U.S. Cl. CPC A47C 31/113; A47C 7/62; G09F 2023/005

(57) ABSTRACT

A seat cover for covering the seat portion of a chair in a public venue includes a shell that is flexible. The shell is waterproof and substantially rectangularly box shaped. The shell has a back, which is open. The back is positioned in the shell such that the shell is configured to substantially envelop the seat of a chair to prevent transfer of moisture and contaminants from the seat to a user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to seat covers and more particularly pertains to a new seat cover for covering the seat portion of a chair in a public venue.

### BRIEF SUMMARY OF THE INVENTION

An embodiment of the disclosure meets the needs presented above by generally comprising a shell that is flexible. The shell is waterproof and substantially rectangularly box shaped. The shell has a back, which is open. The back is positioned in the shell such that the shell is configured to substantially envelop the seat of a chair to prevent transfer of moisture and contaminants from the seat to a user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a seat cover according to an embodiment of the disclosure.

FIG. 2 is an isometric perspective view of an embodiment of the disclosure.

FIG. 3 is a top view of an embodiment of the disclosure.

FIG. 4 is a back view of an embodiment of the disclosure.

FIG. 5 is a cross-sectional view of an embodiment of the disclosure.

FIG. 6 is an isometric perspective view of an embodiment of the disclosure.

### DETAILED DESCRIPTION OF THE INVENTION

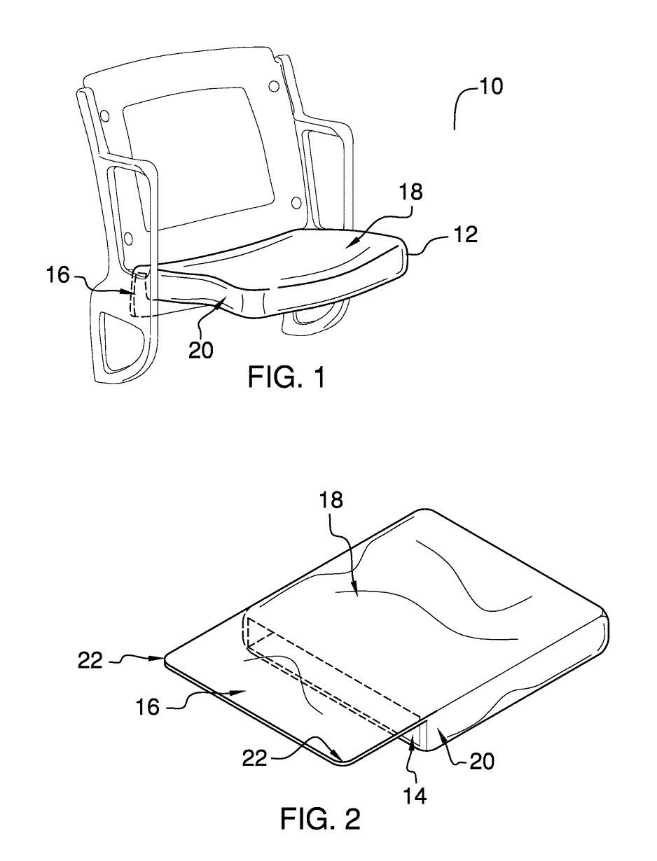

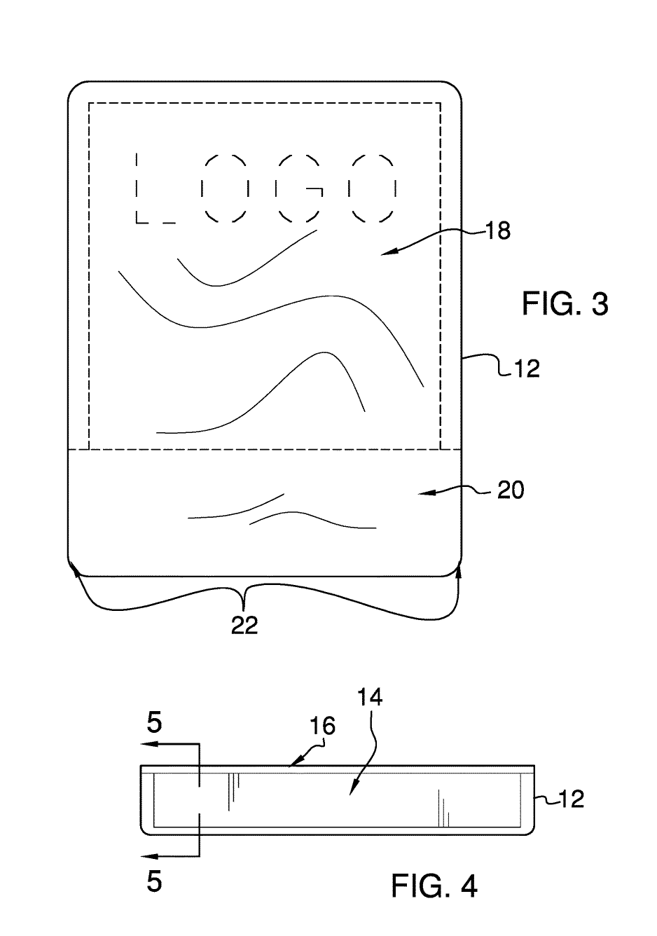

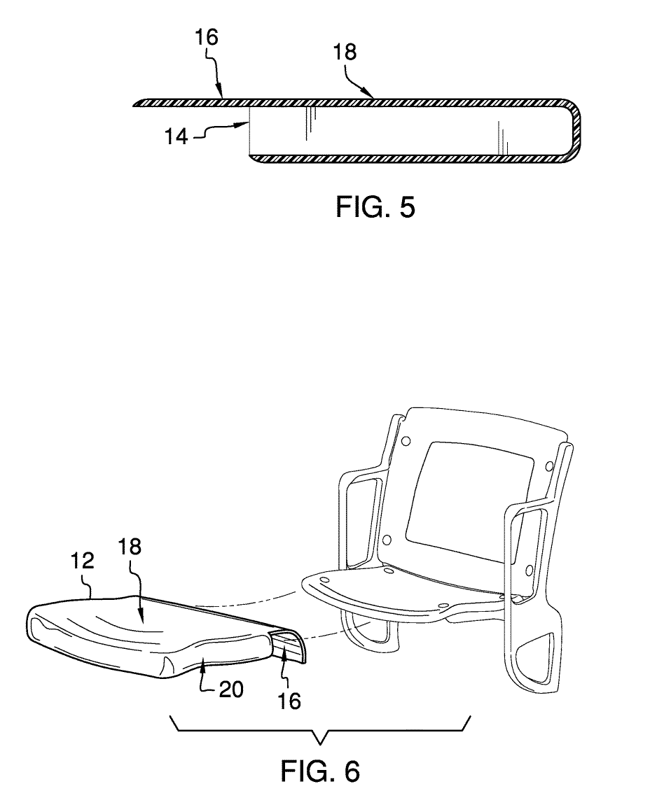

With reference now to the drawings, and in particular to FIGS. 1 through 6 thereof, a new seat cover embodying the principles and concepts of an embodiment of the disclosure and generally designated by the reference numeral 10 will be described.

As best illustrated in FIGS. 1 through 6, the seat cover 10 generally comprises a shell 12 that is flexible. The shell 12 is waterproof and is substantially rectangularly box shaped. The shell 12 has a back 14, which is open. The back 14 is positioned in the shell 12 such that the shell 12 is configured to substantially envelop the seat of a chair, wherein transfer of moisture and contaminants from the seat to a user is prevented. In one embodiment, the shell 12 comprises plastic.

In another embodiment, the shell 12 comprises printable plastic, such that the shell 12 is configured for printing of indicia on the shell 12.

A flap 16 is coupled to a top 18 of the shell 12 and extends between opposing sides 20 of the shell 12. The flap 16 is positioned on the shell 12 such that the flap 16 is configured to insert into a gap defined by the seat and a back 14 of the chair. The flap 16 comprises a pair of corners 22 positioned distal from the shell 12. The corners are rounded.

In use, the back 14 is positioned in the shell 12 such that the shell 12 is configured to substantially envelop the seat of a chair, wherein transfer of moisture and contaminants from the seat to the user is prevented. The flap 16 is configured to insert into the gap defined by the seat and the back 14 of the chair.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A seat cover system comprising:
a chair having a seat coupled to a back;
a shell, said shell being flexible, said shell being waterproof, said shell being substantially rectangularly box shaped, said shell having a back, said back being open; and
wherein said back receives said seat of said chair therethrough wherein said seat is positioned in said shell such that said shell envelops said seat of said chair whereby transfer of moisture and contaminants from the seat to a user is prevented.

2. The system of claim 1, further including said shell comprising plastic.

3. The system of claim 2, further including said shell comprising printable plastic, such that said shell is configured for printing of indicia on said shell.

4. The system of claim 1, further including a flap coupled to a top of said shell and extending between opposing sides of said shell, wherein said flap is positioned on said shell such that said flap is configured for insertion into a gap defined by the seat and a back of the chair.

5. The system of claim 4, further including said flap comprising a pair of corners positioned distal from said shell, said corners being rounded.

6. A seat cover system comprising:
a chair having a seat coupled to a back;
a shell, said shell being flexible, said shell being waterproof, said shell being substantially rectangularly box shaped, said shell having a back, said back being open, wherein said back receives said seat of said chair therethrough wherein said seat is positioned in said shell such that said shell envelops said seat of said chair whereby transfer of moisture and contaminants from the seat to a user is prevented, said shell comprising plastic, said shell comprising printable plastic, such that said shell is configured for printing of indicia on said shell;
a flap coupled to a top of said shell and extending between opposing sides of said shell, wherein said flap is positioned on said shell such that said flap is configured for insertion into a gap defined by the seat and a back of the chair, said flap comprising a pair of corners positioned distal from said shell, said corners being rounded; and
wherein said back is positioned in said shell such that said shell is configured to substantially envelop the seat of a chair, such that said flap is configured for insertion into the gap defined by the seat and the back of the chair, such that transfer of moisture and contaminants from the seat to the user is prevented.
